(19) United States
(12) Patent Application Publication
(10) Pub. No.: US 2015/0036322 A1
(43) Pub. Date: Feb. 5, 2015

(54) BACKLIGHT MODULE

(71) Applicant: HON HAI PRECISION INDUSTRY CO., LTD., New Taipei (TW)

(72) Inventor: PO-CHOU CHEN, New Taipei (TW)

(73) Assignee: HON HAI PRECISION INDUSTRY CO., LTD., New Taipei (TW)

(21) Appl. No.: 14/060,610

(22) Filed: Oct. 22, 2013

(30) Foreign Application Priority Data
Jul. 31, 2013 (TW) 102127380

(51) Int. Cl. G02F 1/1335; F21V 5/04

(52) U.S. Cl. CPC G02F 1/133603; F21V 5/04
USPC 362/97.3

(57) ABSTRACT

A backlight module includes a plurality of LED light sources each generating a light with a large degree of emission, a plurality of lenses, a diffusing plate and two brightness enhancement films. Each lens has a light inputting face and a light outputting face directly adhered to a light inputting face of the light diffusing plate. The light inputting face of each lens is curved and protrudes toward the LED light source. Each LED light source is corresponding to one of the lenses. Light emitted from the LED light sources enters the light inputting faces of the lenses, and exits from the light outputting faces of the lenses. The light outputted from the light outputting faces of the lenses perpendicularly enters the light inputting face of the diffusing plate, and exits from a light outputting face of the diffusing plate to enter the brightness enhancement films.

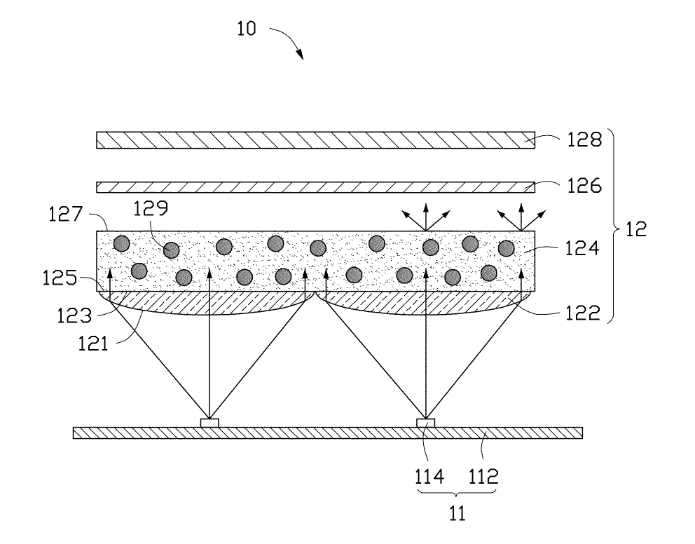

### BACKGROUND

1. Technical Field

The disclosure relates to a backlight module, and particularly to a backlight module with a high light utilizing efficiency.

2. Description of Related Art

A conventional direct type backlight module served as a backlight source for a liquid crystal display device includes a number of LEDs, and a diffusing plate located above the LEDs. Lenses are provided to cover the LEDs, respectively, so that the number of the LEDs needed is reduced since the lenses can convert the light from the LEDs to increase the illumination angle thereof. However, the light inputting angle of the light converted by the lenses in entering the diffusing plate is very large. The larger the light inputting angle of the light entering the diffusing plate, the longer the route of the light extending through the diffusing plate is. Therefore, the penetration rate of the part of the light which is refracted with a large degree by the lens penetrating through the diffusing plate is greatly decreased, and the light utilizing efficiency of the backlight module is thereby decreased.

What is needed, therefore, is a backlight module which can overcome the limitations described above.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

The only drawing is a schematic view of a backlight module in accordance with an embodiment of the disclosure.

### DETAILED DESCRIPTION

Referring to the only drawing, a backlight module 10 in accordance with an embodiment of the disclosure is illustrated. The backlight module 10 is a direct type backlight module which can serve as a backlight source for a liquid crystal display device. The backlight module 10 includes a planar lighting source 11 and an optical film assembly 12. The planar lighting source 11 comprises a base 112 and a plurality of light emitting diode (LED) light sources 114 mounted on the base 112 and arranged in a matrix. The optical film assembly 12 includes a plurality of lenses 122, a diffusing plate 124, and two brightness enhancement films 126, 128. Each LED light source 114 includes an LED chip and a lens over the LED chip, wherein the lens can divergently refract light from the LED chip.

An evenness of light emitted by the LED light sources 114 of the planar lighting source 11 increases via the diffusing plate 124. The diffusing plate 124 has a light inputting face 125 and a light outputting face 127. The light inputting face 125 and the light outputting face 127 are flat surfaces and parallel to each other. A plurality of diffusing grains 129 are contained in an interior of the diffusing plate 124 and located between the light inputting face 125 and the light outputting face 127. The diffusing grains 129 are evenly distributed in the diffusing plate 124.

The two brightness enhancement films 126, 128 are located above the diffusing plate 124. The light extending through the brightness enhancement films 126, 128 is directed in a specific angle (i.e., normal direction) to a liquid crystal panel of the liquid crystal display device.

The lenses 122 are located between the planar lighting source 11 and the diffusing plate 124, and are arranged in a matrix. Each of the lenses 122 has a light inputting face 121 and a light outputting face 123 opposite to the light inputting face 121. The light outputting face 123 is a flat surface and faces the light inputting face 125 of the diffusing plate 124. In this embodiment, the light outputting face 123 of each lens 122 is directly adhered to the light inputting face 125 of the diffusing plate 124. The light inputting face 121 is a curved face protruding towards the LED light source 114.

The number of the LED light sources 114 is equal to the number of the lenses 122. Each of the LED light sources 114 is corresponding to one of the lenses 122, and located at a focal point of the corresponding one of the lenses 122. The light emitted from the LED light sources 114 enters the lenses 122 via the light inputting faces 121 thereof. The light perpendicularly exits from the light outputting faces 123 of the lenses 122, and then perpendicularly enters the light inputting face 125 of the diffusing plate 124, so that the route of the light extending through the diffusing plate 124 is the shortest.

In the backlight module 10 of the present disclosure, since each of the LED light sources 114 is located at the focal point of the corresponding one of the lenses 122, the light emitted from each of the LED light sources 114 with a large angle of emission (i.e., more than 120 degrees) is convergently refracted by the lenses 122 to be parallel light, so that the light output from the lens 122 vertically enters the light inputting face 125 of the diffusing plate 124, and the route of the light extending through the diffusing plate 124 is greatly shortened and uniform. Therefore, the penetration rate of the light penetrating through the diffusing plate 124 is greatly improved, and the light utilizing efficiency of the backlight module 10 is thereby improved.

It is believed that the disclosure and its advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A backlight module comprising:
a plurality of LED light sources;
a plurality of lenses, each of the lenses having a light inputting face and a light outputting face, each of the LED light sources being corresponding to one of the lenses, the light inputting face of each of the lenses facing a corresponding one of the LED light sources, light emitted from the LED light sources entering the lenses from the light inputting faces of the lenses and leaving the lenses from the light outputting faces of the lenses; and
a diffusing plate having a light inputting face and a light outputting face, the light outputting face of each of the lenses facing the light inputting face of the diffusing plate, the light outputted from the light outputting faces of the lenses being convergently refracted by the lenses to perpendicularly enter the light inputting face of the diffusing plate, the light leaving the diffusing plate from the light outputting face of the diffusing plate.

2. The backlight module of claim 1, wherein each of the LED light sources is located at a focal point of a corresponding one of the lenses.

3. The backlight module of claim 1, wherein the light inputting face and the light outputting face of the diffusing plate are flat surfaces.

4. The backlight module of claim 3, wherein the light inputting face and the light outputting face of the diffusing plate are parallel to each other.

5. The backlight module of claim 3, wherein the light outputting face of each of the lenses is directly adhered to the light inputting face of the diffusing plate.

6. The backlight module of claim 5, wherein the light inputting face of each of the lenses is a curved face protruding towards a corresponding one of the LED light sources.

7. The backlight module of claim 1, wherein the lenses are arranged in a matrix.

8. The backlight module of claim 1, further comprising a base, the LED light sources are mounted on the base.

9. The backlight module of claim 8, wherein the LED light sources are arranged in a matrix.

10. The backlight module of claim 1, further comprising two brightness enhancement films located above the diffusing plate.

11. The backlight module of claim 1, further comprising a plurality of diffusing grains contained in an interior of the diffusing plate.

12. The backlight module of claim 11, wherein the diffusing grains are uniformly distributed between the light inputting face and the light outputting face of the diffusing plate.

13. The backlight module of claim 1, wherein the number of the LED light sources is equal to the number of the lenses.
